(19) United States
(12) Patent Application Publication
(10) Pub. No.: US 2005/0126304 A1
(43) Pub. Date: Jun. 16, 2005

(54) FLUID INFUSION METHOD AND SYSTEM THEREFOR

(75) Inventors: Douglas Ray Sparks, Whitmore, MI (US); Nader Najafi, Ann Arbor, MI (US); Stephen Jeffrey Goldner, West Bloomfield, MI (US)

Correspondence Address: HARTMAN & HARTMAN, P.C., 552 EAST 700 NORTH, VALPARAISO, IN, 46383, US

(73) Assignee: INTEGRATED SENSING SYSTEMS, INC., Ypsilanti, MI (US)

(21) Appl. No.: 10/904,690

(22) Filed: Nov. 23, 2004

Related U.S. Application Data
(60) Provisional application No. 60/524,089, filed on Nov. 24, 2003.

(51) Int. Cl. G01F 1/708

(52) U.S. Cl. 73/861.05

(57) ABSTRACT

A system and method for delivering a precise amount of fluid, such as a fluid for medical treatment. The system is a compact, fully-integrated, assembly that includes a sheet configured to be secured to a patient so that a surface of the sheet is held in contact with the patient's skin. The sheet carries a reservoir containing the fluid, a flow sensing device fluidically coupled to the reservoir, a device for initiating and interrupting flow of the fluid from the reservoir to the flow sensing device, a device for introducing the fluid into the patient's body, electronic circuitry for controlling fluid flow based on the output of the flow sensing device, and a power source.

### CROSS REFERENCE TO RELATED APPLICATIONS

This application claims the benefit of U.S. Provisional Application No. 60/524,089, filed Nov. 24, 2003.

### BACKGROUND OF THE INVENTION

The present invention generally relates to fluid handling systems and methods for their use. More particularly, this invention relates to an infusion system, such as for delivering a drug, that is capable of being applied directly to and carried by the user for delivering a precisely controlled amount of a fluid.

Infusion therapy generally involves the administration of a therapeutic fluid (e.g., a drug or medication, hereinafter simply referred to as drugs) to a subject using intravenous (IV), subcutaneous and epidural routes. A wide variety of infusion pumps have been developed over the years that are capable of delivering drugs at a controlled rate. Such pumps include elastomeric, gravity-fed, syringe, electrical, and mechanical pumps. Valves and flow sensors have been incorporated into some infusion pump designs to improve dosage accuracy and to control the flow of drugs through these systems. More recently, micromachined flow sensors, valves and pumps have been developed, some of which have been used in drug delivery applications. Precise fluid control and measurement made possible with the above equipment and devises can also be useful in other medical applications, such as drug compounding and urological and blood analysis.

Certain types of infusion therapies require extremely small amounts of fluids to be delivered in a very precise manner. In these situations, hand-actuated syringes are often not sufficiently accurate. Furthermore, hand-actuated syringes are prone to many types of human errors such as errors in dosage amount, dose rate, and medicine type. Machine-controlled pumps are capable of significantly better accuracy. For example, the accuracy of infusion pumps typically ranges from about ±5% for volumetric pumps, down to about ±3% for syringe pumps. Though Coriolis mass flow sensors can provide flow rate measuring accuracies of under ±1%, their high cost and general requirements for relatively high flow rates have historically restricted their use in the medical field.

Commonly-assigned U.S. Pat. No. 6,477,901 to Tadigadapa et al. discloses a sensing device having a micromachined resonating tube that operates on the basis of the Coriolis effect to sense mass flow and density of a flowing fluid. The device can sense extremely low volumetric flow rates (e.g., less than 1 ml/hr) of the type required by drug delivery applications. The device uses an electrostatic drive and capacitive sensing, and therefore requires little power for its operation. Commonly-assigned and co-pending U.S. patent application Ser. No. 10/248,839 to Sparks utilizes the sensing device disclosed in Tadigadapa et al. in a fluid delivery system capable of delivering a precise amount of fluid and monitoring certain properties of the fluid so that the correct fluid is safely delivered to its intended destination. As such, Sparks' fluid delivery system finds use in the medical field for delivering drugs. Other examples of medical treatments that benefit from the sensing device of Tadigadapa et al. are disclosed in commonly-assigned and co-pending U.S. patent application Ser. Nos. 10/708,509, and 10/709,782.

While Sparks provides significant advancements for infusion systems and treatments, further improvements would be desirable that would yield a more compact, fully-integrated, medical delivery system capable of programmable, time-release delivery of drugs.

### BRIEF SUMMARY OF THE INVENTION

The present invention provides a system and method capable of delivering a precise amount of fluid, such as a fluid required for medical treatment. The system is in the form of a compact, fully-integrated, assembly capable of time-release delivery of medications according to a preprogrammed regiment or in response to changing conditions of the patient. The system is sufficiently compact and integrated to allow the system to be worn by the patient without the mobility of the patient being encumbered by equipment necessary to contain the fluid prior to delivery and control and monitor the delivery of the fluid.

The system of this invention includes a sheet configured to be secured to a surface of the body of a patient so that a surface of the sheet is held in contact with the body surface. A reservoir is supported on the sheet and contains the fluid, such as a medication, drug, etc., intended for treatment of the patient. A flow sensing device is also supported on the sheet and is fluidically coupled to the reservoir. The flow sensing device generates at least one output signal based on flow of the fluid therethrough. The sheet also carries a device for initiating and interrupting flow of the fluid from the reservoir and through the flow sensing device, and a device fluidically coupled to the flow sensing device for introducing into the body through the surface thereof the fluid flowing from the reservoir and through the flow sensing device. Electronic circuitry is supported on the sheet for controlling the initiating and interrupting of fluid flow and receiving the output signal from the flow sensing device. Finally, the sheet also carries a device for powering the components on the sheet that require electrical power, e.g., the flow sensing device and the electronic circuitry.

The method of this invention involves the use of a sheet having a fluid infusion system thereon that comprises a reservoir containing the fluid, a flow sensing device fluidically coupled to the reservoir, and electronic circuitry, such as but not limited to the system described above. The sheet is applied to a surface of a patient's body so that a surface of the sheet is held in contact with the patient's body. The electronic circuitry is then operated to initiate flow of the fluid from the reservoir and through the flow sensing means, and to receive from the flow sensing device an output signal based on flow of the fluid through the flow sensing device. The fluid that has flowed from the reservoir and through the flow sensing device is then introduced into the patient's body through the surface of the body.

The system as described above can be made sufficiently compact and integrated to enable it to be physically worn by a patient, yet capable of delivering a precise amount of fluid to the patient. By utilizing a Coriolis flow sensor of the type disclosed by Tadigadapa et al. and a passive pump, the system can be a small, low-cost, low-power medical delivery product capable of programmable, time-release delivery of a drug. The system also provides the capability of being single-use, such that all or part of the system is discarded once removed from the patient. The functionality of the system and method can be enhanced by using a remote device to control the delivery of the fluid according to a preprogrammed regiment or in continuous response to any physiological changes that occur within the patient. The system can also be equipped to store data and other information in memory, and/or relay such data and information to a remote device. Based on the data and information, the flow of the fluid can be initiated, increased, decreased, and stopped at any time according to the needs of the patient.

Other objects and advantages of this invention will be better appreciated from the following detailed description.

### BRIEF DESCRIPTION OF THE DRAWINGS

FIG. 1 is a schematic representation of a side view of a fluid delivery system in accordance with an embodiment of this invention.

FIG. 2 is a schematic representation of a plan view of the fluid delivery system of FIG. 1.

### DETAILED DESCRIPTION OF THE INVENTION

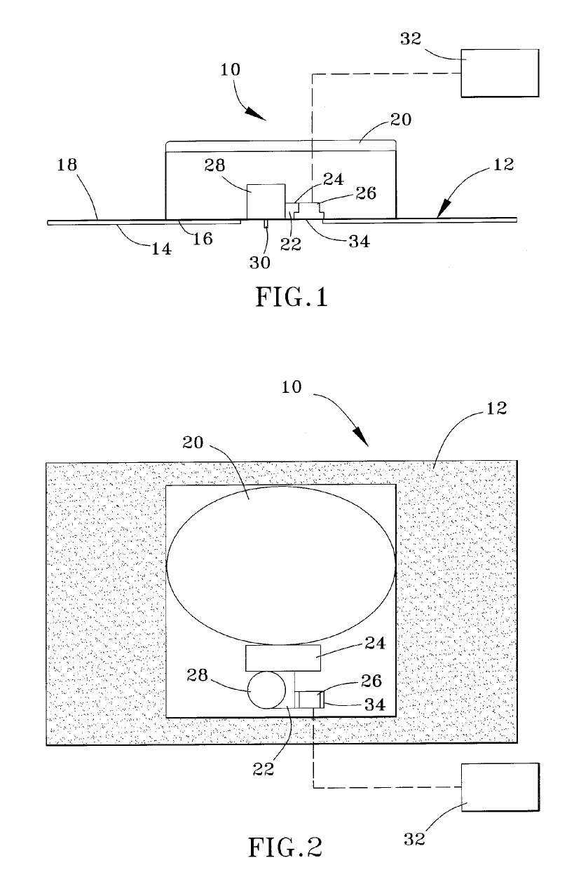

With reference to FIGS. 1 and 2, a fluid delivery system 10 is shown that may be described as a patch 12 that carries various components necessary to safely deliver a controlled amount of a fluid, such as drug or medication (hereinafter, simply “drug”) to a subject wearing the patch 12. While the intended subject will often be a person, it should be understood that the system 10 and method of this invention can also be applied to an animals or other subject, who will hereinafter be referred to as the patient. The system 10 can be adapted to administer a drug by a variety of delivery devices and techniques, e.g., transdermal absorption, needle, microneedle array, intravenous (IV), intra-arterial (IA), subcutaneous, intramuscular (IM), intraperitoneal (IP), intrathecal, etc. As will become evident from the following, a variety of fluid sources could be used by the system 10, such as Y-ties, septums, machine-controlled pumps, IV primer/drip chambers, etc. However, the benefits of the system 10, including the mobility of the patient wearing the system 10, are best achieved by incorporating the fluid source onto the patch 12, as discussed below.

The patch 12 is shown as having a sheet-like construction typical of a bandage. As such, the patch 12 may be formed of a fabric or sheet of any suitable material, though in accordance with certain embodiments of the invention the patch 12 should allow transdermal absorption of the drug into the patient's skin. According to a preferred aspect of this invention, the patch 12 carries an adhesive 14 on its lower surface 16 by which the patch 12 can be temporarily but firmly held in contact with the body of the patient being treated. However, it is foreseeable that the patch 12 could be secured to the patient with an elastic wrap, tape, etc. On its opposite surface 18, the patch 12 carries various components used by this invention to deliver the drug to the patient. In particular, FIGS. 1 and 2 depict a reservoir 20, a flow sensor 22, a valve assembly 24, a circuit chip 26, and a battery 28 mounted to the upper surface 18 of the patch 12, and therefore opposite the adhesive 14. While FIGS. 1 and 2 depict the components of the system 10 as being exposed on the upper surface 18 of the patch 12, it is foreseeable that an enclosure could be provided for protecting these components from the environment.

The reservoir 20 is shown as being a bladder-like body, which in a preferred embodiment is capable of containing the drug under pressure. For this reason, the reservoir 20 can be a bladder formed of an elastomeric material, though other possible forms include a spring-powered syringe, a spring-loaded bladder, etc. In any event, a preferred reservoir 20 is able to perform as a passive pump that does not require electrical energy to dispense the drug, though a reservoir 20 equipped with a pump is also within the scope of this invention. The drug contained by the reservoir 20 is preferably maintained at pressurizes above atmospheric pressure.

The flow sensor 22 is fluidically coupled to the reservoir 20 and adapted to sense the flow of the drug from the reservoir 20 prior to being delivered to the patient, such as through the needle 30 shown in FIG. 1 on the opposite (lower) surface 16 of the patch 12. While a single reservoir 20 and flow sensor 22 are depicted in FIGS. 1 and 2, the system 10 could be adapted to make use of a number of reservoirs 20 and sensors 22 to separately deliver multiple drugs and/or deliver drugs from different reservoirs 20 that are mixed just prior to infusion. While a variety of sensors are capable of being used with the system 10 of this invention, a preferred flow sensing device is the Coriolis-type resonating tube flow sensor taught in U.S. Pat. No. 6,477,901 to Tadigadapa et al., whose discussion of the construction and operation of the flow sensor thereof is incorporated herein by reference. In accordance with Tadigadapa et al., the preferred flow sensor 22 of this invention comprises a tube that serves as a conduit through which the fluid flows as it flows between the inlet and outlet of the sensor 22. The tube has a freestanding portion adapted to be vibrated at resonance in a manner that enables certain properties of the fluid to be measured using Coriolis force principles. When vibrated at resonance, fluid flowing through the tube causes the freestanding portion to twist under the influence of the Coriolis effect. As explained in Tadigadapa et al., the degree to which the freestanding portion twists (deflects) when vibrated can be correlated to the mass flow rate of the fluid flowing through the tube on the basis of the change in the amplitude of a secondary resonant vibration mode. The density of the fluid is proportional to the natural frequency of the fluid-filled vibrating portion, such that controlling the vibration of the freestanding portion to maintain a frequency at or near its resonant frequency will result in the vibration frequency changing if the density of the fluid flowing through the tube changes.

The flow sensor of Tadigadapa et al. is preferred for use as the flow sensor 22 of this invention, though it is foreseeable that other types of flow sensors could be employed. For example, hot-wire (thermal), thin-film (e.g., piezoresistive and piezoelectric), and drag force flow sensors known in the art could be employed by the system 10. Such alternative sensors can be micromachined microelectromechanical systems (MEMS), and could potentially be formed on a single chip or substrate. However, a disadvantage of hot-wire and thin-film flow sensors is that they can damage delicate biological molecules used in some medical treatments. Furthermore, particularly advantageous aspects of the flow sensor of Tadigadapa et al. include its very small size and its ability to precisely measure extremely small amounts of fluids, such as at flow rate measurement accuracies of under ±1%. Another advantage of the flow sensor of Tadigadapa et al. is its use of an electrostatic drive and capacitive sensing, which minimizes the power requirements of the sensor. Accordingly, the flow sensor taught by Tadigadapa et al. is ideal for achieving the high accuracy, small size, and low power requirements desired by the system 10 of this invention.

The system 10 depicted in FIGS. 1 and 2 is represented as using a single needle 30 to introduce the drug into the body of the patient wearing the patch 12. However, it should be understood that various devices could be employed to achieve the variety of delivery techniques noted above. In view of the duration over which the patch 12 would be worn, transdermal absorption is a particularly attractive mode of delivering a drug with the system 10 of this invention. Nonetheless, the needle 30 represented seen FIG. 1 is also a viable medium for drug delivery in accordance with this invention. Also within the scope of this invention are, merely by example, microneedle arrays and cannulas adapted for intravenous (IV), intra-arterial (IA), subcutaneous, intramuscular (IM), intraperitoneal (IP), intrathecal, ultrasonic, electrostatic, etc., delivery.

The valve assembly 24 operates to initiate, regulate, and interrupt the flow of fluid from the reservoir 20 to the needle 30. FIG. 2 shows the valve assembly 24 as being between the flow sensor 22 and the reservoir 20, though it is foreseeable that the valve assembly 24 could be placed downstream of the flow sensor 22. As with the flow sensor 22, the valve assembly 24 can be a micromachined MEMS device. While shown as being a discrete component, the valve assembly 24 could be fabricated with the sensor 22 on a single chip or substrate. Various types of devices could be used as the valve assembly 24, though the preferred valve assembly 24 provides the capability of incrementally increasing and decreasing the flow of fluid to the flow sensor 22 in order to not only initiate and interrupt drug flow, but also to control the rate at which the drug is administered to the wearer of the patch 12. For this reason, the valve assembly 24 is preferably a proportional valve.

Together, the flow sensor 22 and valve assembly 24 enable the reservoir 20 to controllably deliver a precise amount of drug to the needle 30. As previously discussed, the flow sensor 22 is preferably adapted to detect the mass flow rate and density of the delivered fluid, and these parameters as well as the volumetric flow rate computed therefrom can then be used to regulate the delivery of the drug through control of the valve assembly 24. For this purpose, electronic circuitry (not shown) is preferably carried on the circuit chip 26, by which appropriate control signals to the valve assembly 24 can be generated based on the output of the flow sensor 22. The circuit chip 26 is preferably programmable, and can be employed to independently control the delivery of the drug to the patient wearing the patch 12 using a timed or preprogrammed dose approach. In a preferred embodiment, the circuit chip 26 is further adapted for communication with a remote device 32, such as a sensor, computer, microprocessor, etc., that is operatively coupled to the circuit chip 26 via a communication port 34. While the chip 26 could be hard wired to the device 32, preferred communication techniques are wireless, such as, by way of example, IR, RF, optical, magnetic, etc.

If a computer or microprocessor, the remote device 32 can be used to operate the system 10 using a timed or preprogrammed dose approach. For example, the remote device 32 can communicate with the circuit chip 26 to receive output signals from the chip 26 based on the flow parameters sensed by the flow sensor 22, and to deliver control signals to the chip 26 by which the valve assembly 24 is controlled. Such a remote device 32 can also provide a display panel (not shown) by which the operating conditions of the system 10 are displayed. Using timing circuitry (not shown) carried on the circuit chip 26 or the remote device 32, the chip 26 can be used to trigger when the valve assembly 24 permits fluid flow from the reservoir 20, calculate and display the actual amount of fluid dispensed through the flow sensor 22 to give an accurate indication of the amount of drug delivered through the needle 30, and regulate the incremental opening and closing of the valve assembly 24 to achieve a desired flow rate. As a computer, the remote device 32 can also be used to store data and other information in memory for later retrieval, and/or relay such data and information to another remote computer or a telephone system through which the system 10 can be monitored and controlled.

If a sensor, the remote device 32 can be used to monitor various physiological parameters of the patient to control the timing and amount of drug dispensed by the system 10. For example, the remote device 32 could be a glucose sensor used to monitor the glucose level of the blood. When the glucose level goes above or below preset limits programmed into the chip 26, the device 32, or another remote device (e.g., a computer), the output of the device 32 or an appropriate signal can be delivered to the chip 24, which then signals the valve assembly 24 to initiate, increase, decrease, or interrupt the delivery of insulin, as the circumstances may require. Continuous monitoring of the dosage by the flow sensor 22 and sensing of the glucose level by the remote device 32 provide closed-loop control that can be performed by the circuit chip 26 alone or in conjunction with a remote computer, etc. For example, a remotely-controlled drug delivery system may comprise one or more drug delivery systems 10, one or more sensors, and one or more control (decision making) systems. One or more of the sensors can be part of the control system, while other sensors may be distributed.

Another option is for the remote device 32 to be capable of drawing blood for analysis, and then again using the system 10 as a closed-loop drug infusion system responsive to a physiological parameter sensed by the device 32. Depending on the manner in which the drug is delivered into the body of the patient (e.g., with the needle 30), the system 10 can be adapted to treat diabetes, cancer, pain, etc. Other sensors, such as those capable of sensing pH, temperature, respiration rate, pulse, oxygen, or other possible chemical or physiological responses to the treatment, could also be employed as one or more remote devices 32 for use in the system 10.

Power for the system 10, and specifically the valve assembly 24, flow sensor, and circuit chip 26, is provided by the battery 28. Alternative power sources include solar cells, fuel cells, Peltier panels, piezoelectric crystals, etc. Whatever the power source, the power demands of the system 10 can be minimized as a result of using the flow sensor 22 of Tadigadapa et al. and by configuring the valve assembly 24 to operate in a normally closed-loop mode.

In use, the fluid delivery system 10 of this invention makes possible a method by which a drug can be controllably administered to a patient by applying (e.g., adhering) the patch 12 to the patient's skin, so that the lower surface 16 of the patch 12 is held in contact with the skin. In most cases, the patch 12 can be attached essentially anywhere on the patient, while with other treatments it may be desirable to attach the patch 12 locally over the site of a tumor, lesion, rash, injury, organ, or other affected tissue or localized disease site which treatment is desired to be concentrated. By placing the patch 12 on the patient, the needle 30 (or other delivery device) is positioned and, if appropriate, penetrates the patient's skin. Thereafter, the electronic circuitry on the circuit chip 26 and the valve assembly 24 can be energized and operated to initiate flow of the drug from the reservoir 20, through the flow sensor 22, and into the patient. Energizing the chip 26 also enables circuitry on the chip 26 to receive the output signal(s) from the flow sensor 22, such that the fluid's mass flow rate, density, and/or the volumetric flow rate computed therefrom are monitored by the system 10. If so equipped, output of the electronic circuitry can be relayed to the remote device 32, by which the flow of fluid from the reservoir 20 can be controlled on the basis of time (if the remote device 32 is a computer) or physiological parameters of the patient (if the remote device 32 is a sensor). At any time, the flow of fluid from the reservoir 20 can be initiated, increased, decreased, or stopped in response to a preset elapsed time or in response to one or more sensed physiological parameters of the patient. Once treatment is completed, the system 10 can be removed from the patient and readied for reuse. The components of the system 10 can be mounted to the patch 12 to facilitate cleaning of the fluid-contacting components, e.g., the reservoir 20, fluid sensor 22, valve assembly 24, and needle 30. Alternatively, the system 10 can be constructed so that one or more of the fluid-contacting components of the system 10 can be discarded, particularly the relatively inexpensive reservoir 20.

As previously noted, the patch 12 can be modified to carry more than one drug by including one or more additional sets of reservoirs 20, flow sensors 22, valve assemblies 24, and needles 30 (or other delivery device). For this purpose, the circuit chip 26 can be fabricated to have circuitry that enables the delivery of multiple drugs simultaneously or sequentially, and to enable the delivery procedure to be controlled and reprogrammed by a care giver.

The system 10 of this invention, with its capability of controllably delivering doses at rates of less than one milliliter per hour, can potentially find use with experimental drugs, and open up the possibility of safely delivering existing drugs that could not otherwise be delivered safely using existing methods. In effect, the system 10 of this invention is able to dispense medications similar to an advanced time-released pill, but without being limited to pill-type formulations and oral delivery. As such, the system 10 of this invention can potentially be used to tailor the administration of a variety of existing and generic drugs to achieve greater efficacy, enabling such drugs to become more competitive with newer generations of drugs.

In addition to the above, there are a number of drug treatments in which the tight flow rate control or dosages made possible with this invention are extremely beneficial. Drugs having a narrow therapeutic index (NTI) or range are defined by the FDA on the basis of the ratio of the median effective dose value of a drug and its median lethal dose or minimum toxic concentration, and whether safe and effective use of the drug requires careful titration and patient monitoring. Such drugs must be administered carefully, as errors in the dose or delivery rate can injure or kill a patient. Additional drugs fall into this category if the patient is an infant or child. Drugs that patients may have an allergic reaction to are also excellent candidates for use with the system 10 of this invention. For this purpose, the system 10 can be operated to gradually administer the drug with very small, gradually increasing doses to begin desensitizing the patient, permitting the administration of antihistamines if a reaction occurs with the drug. Multiple drugs can be administered in this manner with the system 10, including antibiotics and drugs used to treat diseases such as cystic fibrosis, listeria endocarditis and HIV-related PCP.

While the invention has been described in terms of certain embodiments, it is apparent that other forms could be adopted by one skilled in the art. Therefore, the scope of the invention is to be limited only by the following claims.

1. A system for delivering a fluid into the body of a patient, the system comprising:
a sheet having oppositely-disposed first and second surfaces;
means for securing the sheet to a surface of the body of the patient so that the first surface of the sheet is held in contact with the surface of the body;
a reservoir supported on the sheet and containing the fluid;
a flow sensing device supported on the sheet and fluidically coupled to the reservoir, the flow sensing device generating at least one output signal based on flow of the fluid through the flow sensing device;
means supported on the sheet for initiating and interrupting flow of the fluid from the reservoir and through the flow sensing device;
means supported on the sheet and fluidically coupled to the flow sensing device for introducing into the body through the surface thereof the fluid that flows from the reservoir and through the flow sensing device;
electronic circuitry supported on the sheet and having means for receiving the output signal from the flow sensing device and means for controlling the flow initiating and interrupting means; and
means supported on the sheet for powering the flow sensing device, the flow initiating and interrupting means, and the electronic circuitry.

2. The system according to claim 1, wherein the flow sensing device is configured to produce a first output signal corresponding to the density of the fluid flowing therethrough and produce a second output signal corresponding to the mass flow rate of the fluid flowing therethrough.

3. The system according to claim 1, wherein the electronic circuitry produces an electrical output based on the output signal of the flow sensing device, the system further comprises means supported on the sheet for communication between the electronic circuitry and at least one remote device that is not physically coupled to the system, and the communication means relays the electrical output to the remote device.

4. The system according to claim 3, wherein the output signal of the flow sensing device corresponds to a volumetric flow rate of the fluid flowing through the flow sensing device, the system further comprising means for measuring elapsed time during which the fluid has flowed through the flow sensing device.

5. The system according to claim 4, wherein the electronic circuitry is operable to cause the flow initiating and interrupting means to stop flow of the fluid through the flow sensing device in response to the elapsed time measured by the measuring means and the output signal of the flow sensing device.

6. The system according to claim 1, wherein the output signal of the flow sensing device corresponds to a volumetric flow rate of the fluid flowing through the flow sensing device.

7. The system according to claim 6, wherein the electronic circuitry is operable to cause the flow initiating and interrupting means to selectively increase and decrease flow of the fluid through the flow sensing device in response to the output signal of the flow sensing device.

8. The system according to claim 1, further comprising means supported on the sheet for communication between the electronic circuitry and at least one remote device that is not physically coupled to the system, wherein the electronic circuitry is operable to cause the flow initiating and interrupting means to selectively initiate, increase, decrease, and interrupt flow of the fluid through the flow sensing device in response to a signal received from the remote device via the communication means.

9. The system according to claim 1, wherein the flow sensing device is configured to operate on the basis of the Coriolis effect to measure the density and the mass flow rate of the fluid flowing therethrough.

10. The system according to claim 1, wherein the securing means is an adhesive on the first surface of the sheet.

11. The system according to claim 1, wherein the introducing means comprises means for injecting the fluid beneath the surface of the body.

12. The system according to claim 1, wherein the introducing means comprises a needle on the first surface of the sheet.

13. The system according to claim 1, wherein the introducing means comprises means for causing transdermal absorption of the fluid into the surface of the body.

14. The system according to claim 1, wherein the reservoir, the flow sensing device, the flow initiating and interrupting means, the electronic circuitry, and the powering means are supported on the second surface of the sheet.

15. The system according to claim 14, wherein the securing means is an adhesive on the first surface of the sheet.

16. The system according to claim 15, wherein the introducing means comprises means for injecting the fluid beneath the surface of the body.

17. The system according to claim 15, wherein the introducing means comprises means for causing transdermal absorption of the fluid into the surface of the body.

18. The system according to claim 1, wherein the fluid within the reservoir is at a pressure above atmospheric pressure.

19. The system according to claim 1, further comprising means supported on the sheet for communication between the electronic circuitry and at least one remote device that is not physically coupled to the system, wherein the output signal of the flow sensing device corresponds to a volumetric flow rate of the fluid flowing through the flow sensing device, the communication means relays an input signal from the remote device to the electronic circuitry, and the electronic circuitry is operable to cause the flow initiating and interrupting means to selectively initiate, increase, decrease, and interrupt flow of the fluid through the flow sensing device in response to the output signal of the flow sensing device and the input signal of the remote device.

20. The system according to claim 19, wherein the input signal received from the remote device corresponds to a parameter of the body of the patient sensed by the remote device.

21. The system according to claim 1, further comprising at least a second reservoir supported on the sheet and containing a second fluid.

22. The system according to claim 21, wherein the system is operative to mix the fluid and the second fluid before the fluid and the second fluid are introduced into the body by the introducing means.

23. The system according to claim 21, wherein the system is operative to separately introduce the fluid and the second fluid into the body through the surface thereof.

24. A method for delivering a fluid into the body of a patient, the method comprising:
providing a sheet have a fluid infusion system thereon, the fluid infusion system comprising a reservoir containing the fluid, a flow sensing device fluidically coupled to the reservoir, and electronic circuitry;
applying the sheet to a surface of the body of the patient so that a first surface of the sheet is held in contact with the surface of the body;
operating the electronic circuitry to initiate flow of the fluid from the reservoir and through the flow sensing means, and to receive from the flow sensing device an output signal based on flow of the fluid through the flow sensing device; and
introducing through the surface of the body the fluid that has flowed from the reservoir and through the flow sensing device.

25. The method according to claim 24, wherein the flow sensing device produces a first output signal corresponding to the density of the fluid flowing therethrough and produces a second output signal corresponding to the mass flow rate of the fluid flowing therethrough.

26. The method according to claim 24, wherein the electronic circuitry produces an electrical output based on the output signal of the flow sensing device, and the electrical output is relayed to at least one remote device.

27. The method according to claim 26, wherein the output signal of the flow sensing device corresponds to a volumetric flow rate of the fluid flowing through the flow sensing device, the method further comprising measuring elapsed time during which the fluid has flowed through the flow sensing device.

28. The method according to claim 27, further comprising the step of stopping flow of the fluid through the flow sensing device in response to the elapsed time and the output signal of the flow sensing device.

29. The method according to claim 24, wherein the output signal of the flow sensing device corresponds to a volumetric flow rate of the fluid flowing through the flow sensing device, the method further comprising the steps of selectively increasing and decreasing flow of the fluid through the flow sensing device in response to the output signal of the flow sensing device.

30. The method according to claim 24, wherein the first surface of the sheet is held in contact with the surface of the body by an adhesive on the first surface of the sheet.

31. The method according to claim 24, wherein the introducing step comprises injecting the fluid beneath the surface of the body.

32. The method according to claim 24, wherein the introducing step comprises transdermal absorption of the fluid into the surface of the body.

33. The method according to claim 24, further comprising the steps of selectively initiating, increasing, decreasing, and interrupting flow of the fluid through the flow sensing device in response to a signal received from at least one remote device.

34. The method according to claim 24, wherein the output signal of the flow sensing device corresponds to a volumetric flow rate of the fluid flowing through the flow sensing device, the method further comprises the steps of relaying an input signal from at least one remote device to the electronic circuitry, and the electronic circuitry selectively initiates, increases, decreases, and interrupts flow of the fluid through the flow sensing device in response to the output signal of the flow sensing device and the input signal of the remote device.

35. The method according to claim 34, wherein the input signal received from the remote device corresponds to a parameter of the body of the patient sensed by the remote device.

36. The method according to claim 24, wherein the fluid infusion system comprises a second reservoir containing a second fluid and a second flow sensing device fluidically coupled to the second reservoir, and the electronic circuitry controls delivery of the second fluid from the second reservoir, through the second flow sensing means, and through the surface of the body.

37. The method according to claim 36, wherein the electronic circuitry causes the second fluid to be delivered from the second reservoir, through the second flow sensing means, and through the surface of the body simultaneously with the delivery of the fluid from the reservoir, through the flow sensing means, and through the surface of the body.

38. The method according to claim 24, wherein the fluid infusion system comprises a second reservoir containing a second fluid, and the electronic circuitry controls delivery of the second fluid from the second reservoir and mixing of the second fluid with the fluid from the reservoir prior to introducing the fluid and the second fluid through the surface of the body.

39. The method according to claim 24, further comprising the step of removing the sheet and its fluid infusion system from the surface of the body and discarding the sheet and its fluid infusion system.

40. The method according to claim 24, further comprising the step of removing the sheet and its fluid infusion system from the surface of the body and discarding at least one of the reservoir and the flow sensing device.
